(19) United States
(12) Patent Application Publication
(10) Pub. No.: US 2008/0265478 A1
(43) Pub. Date: Oct. 30, 2008

(54) WIND TURBINE SYSTEMS DAMPERS

(76) Inventors: Tyn Smith, Lakewood, NY (US); Keith R. Ptak, Erie, PA (US); Bryan Haltom, Cary, NC (US)

Correspondence Address: LORD CORPORATION, 111 LORD DRIVE, CARY, NC, 27511, US

(21) Appl. No.: 12/026,332

(22) Filed: Feb. 5, 2008

Related U.S. Application Data
(60) Provisional application No. 60/899,492, filed on Feb. 5, 2007.

(51) Int. Cl. F03D 11/00; F16F 9/14

(52) U.S. Cl. 267/124; 267/140.13

(57) ABSTRACT

A damper for a structural tower having a space frame construction for high elevation and heavy load applications is disclosed, with particular application directed to wind turbines. The structural tower includes one or more dampers for damping resonant vibrations or vibrations generated by non-periodic wind gusts or sustained high wind speeds. The wind tower damper includes a fluid damper comprising a housing, elastomeric chamber, piston and damping fluid, wherein relative motion between the first and second structural members drive the fluid moving piston to pump the fluid and thereby dissipate unwanted motion in the tower.

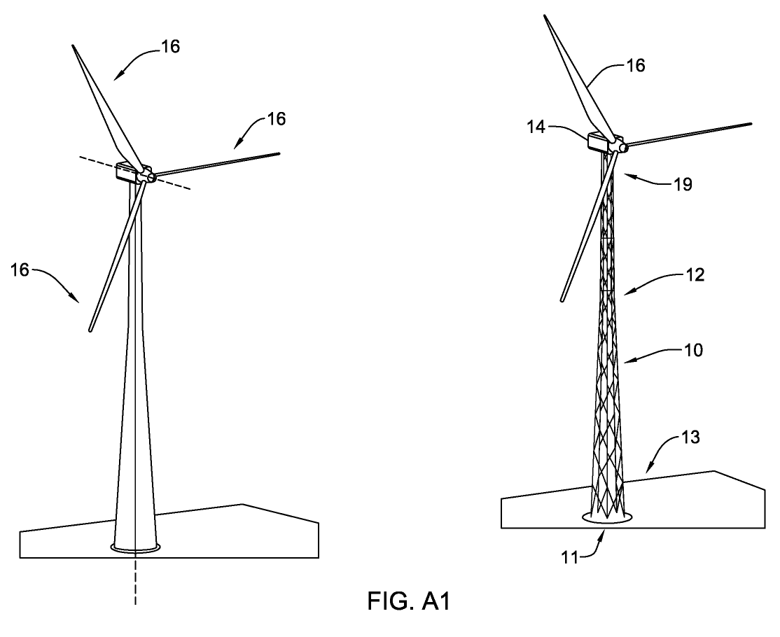

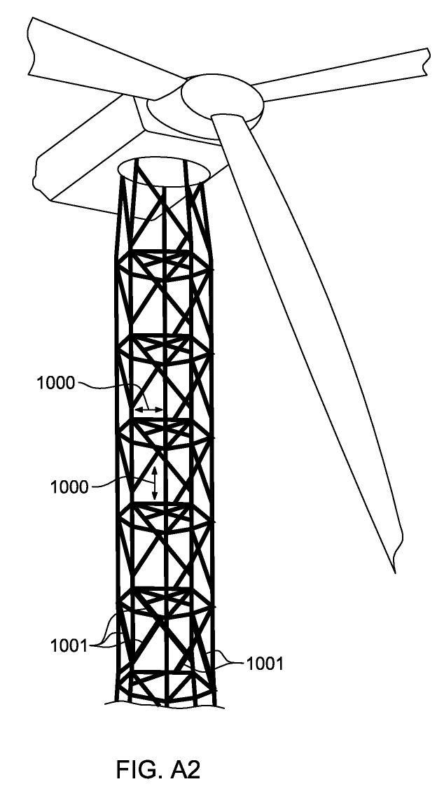

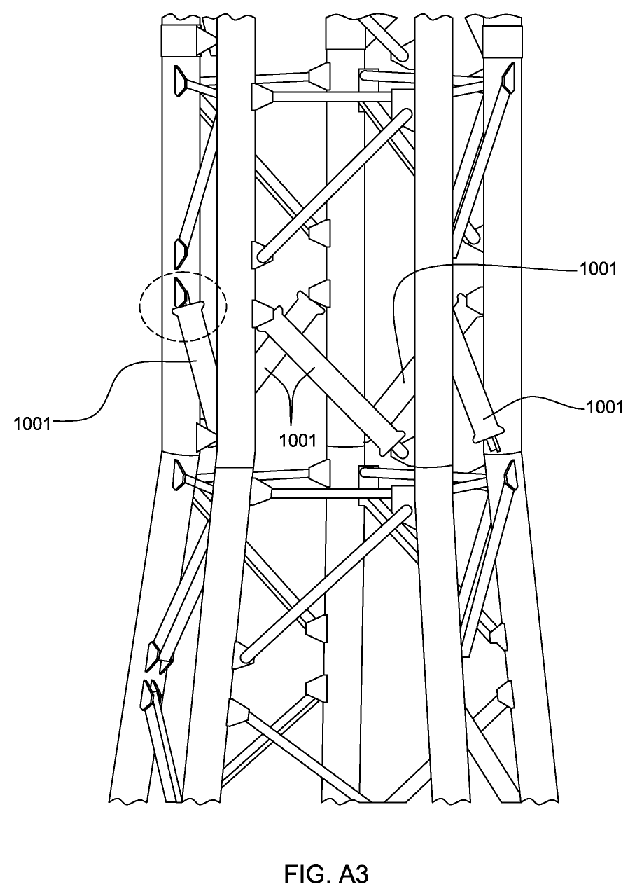

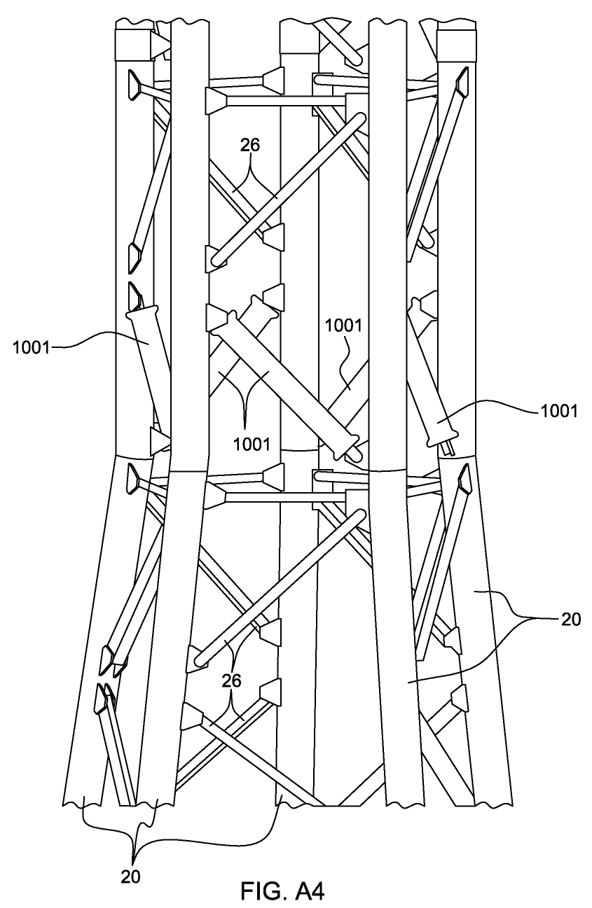

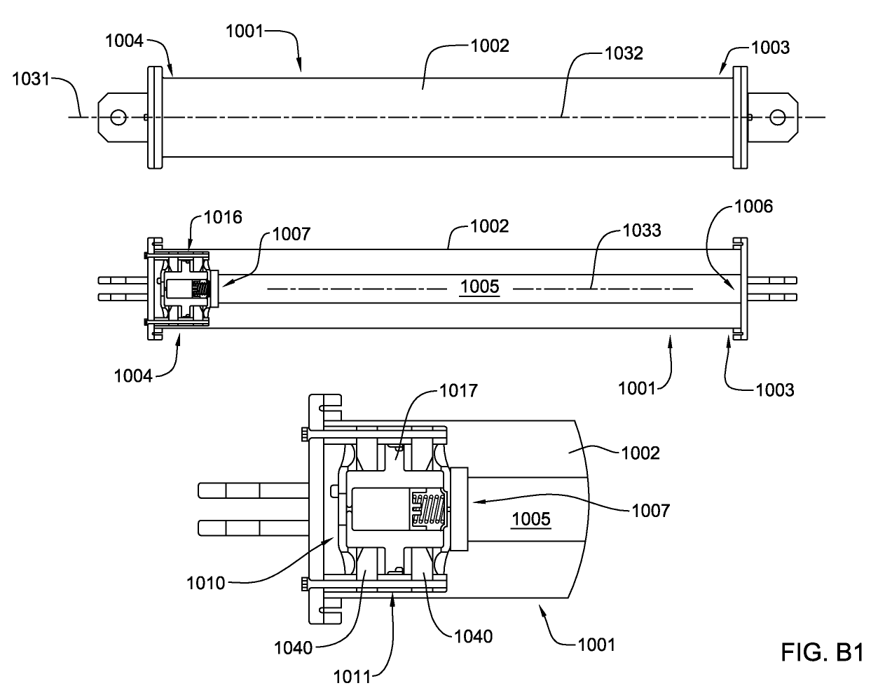

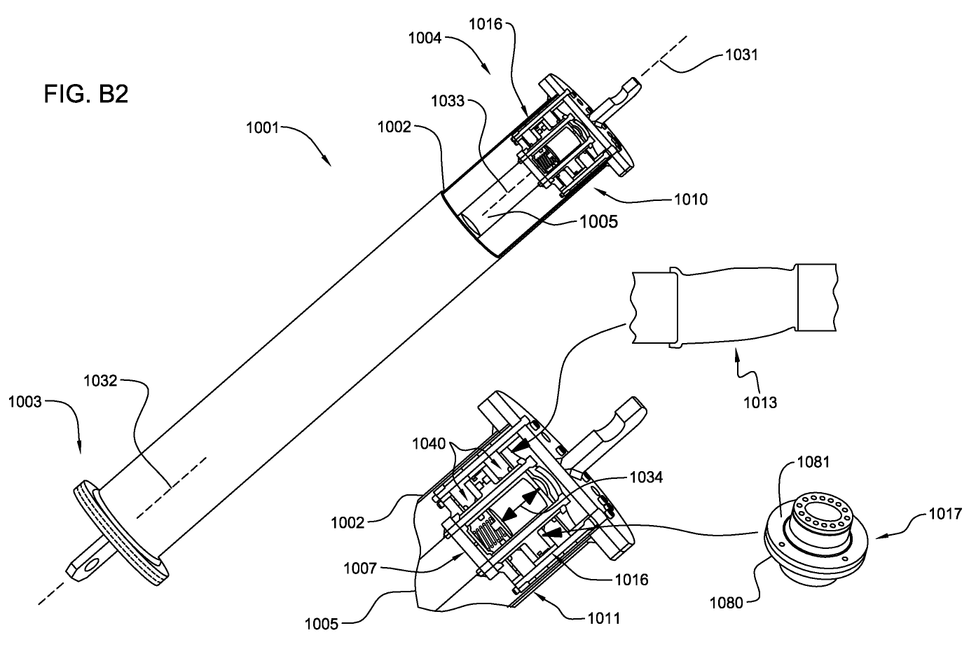

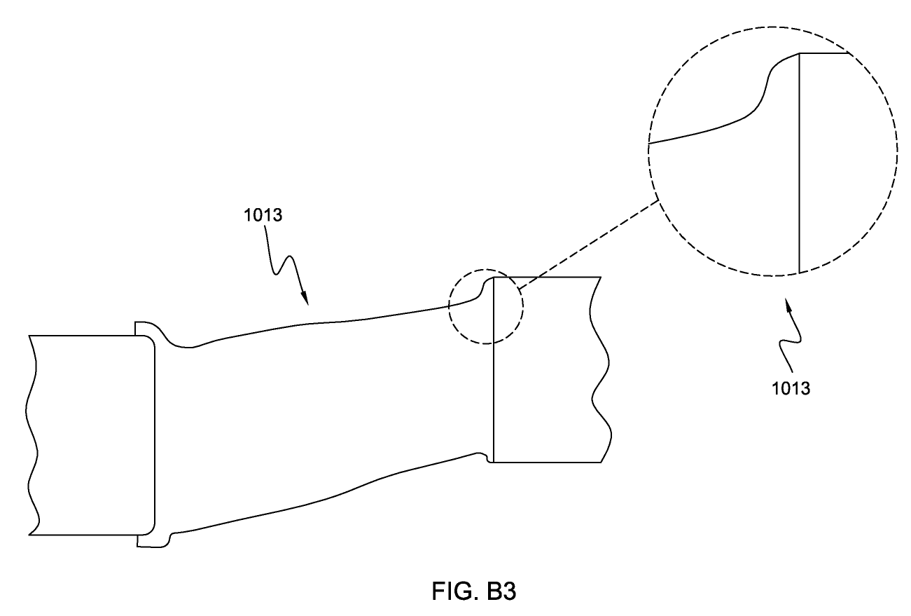

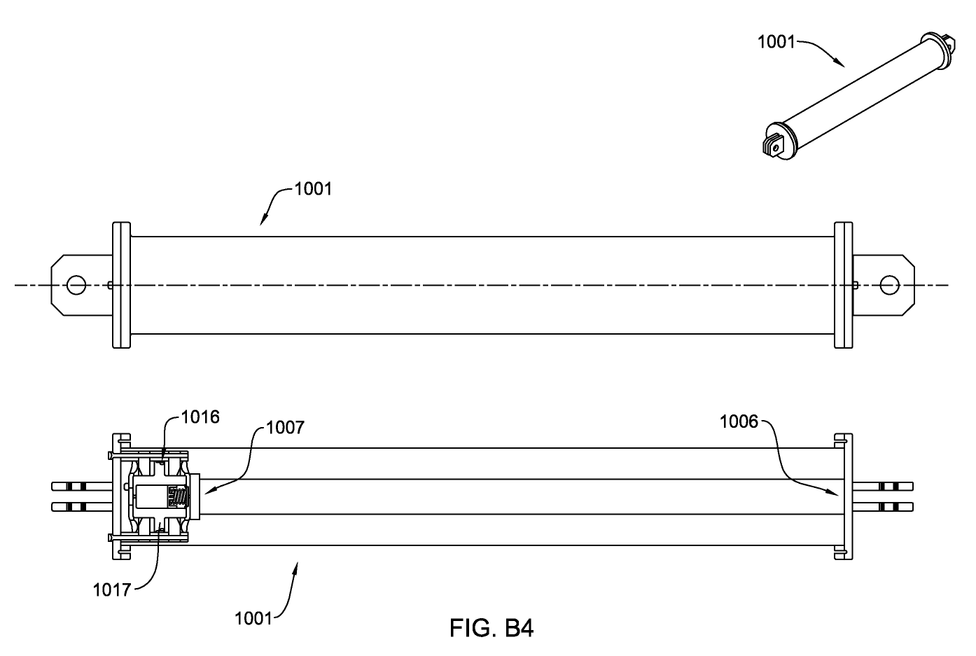

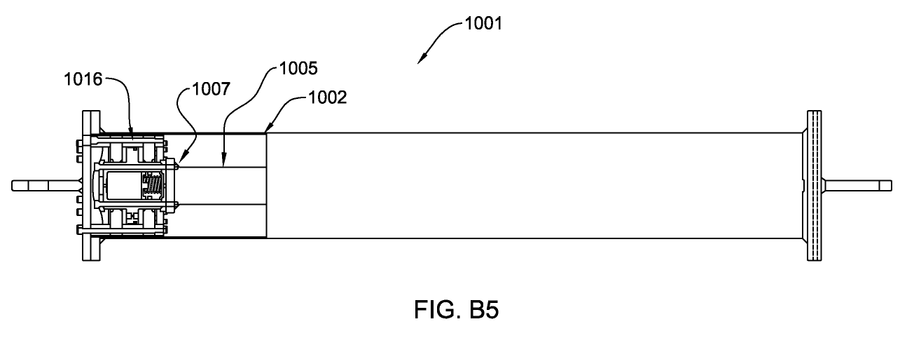

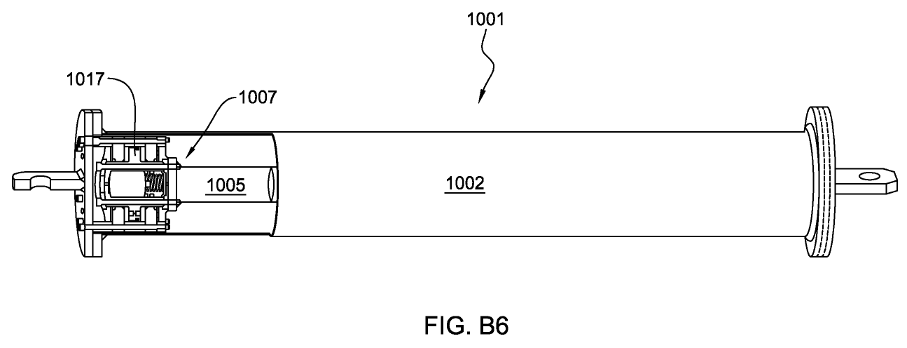

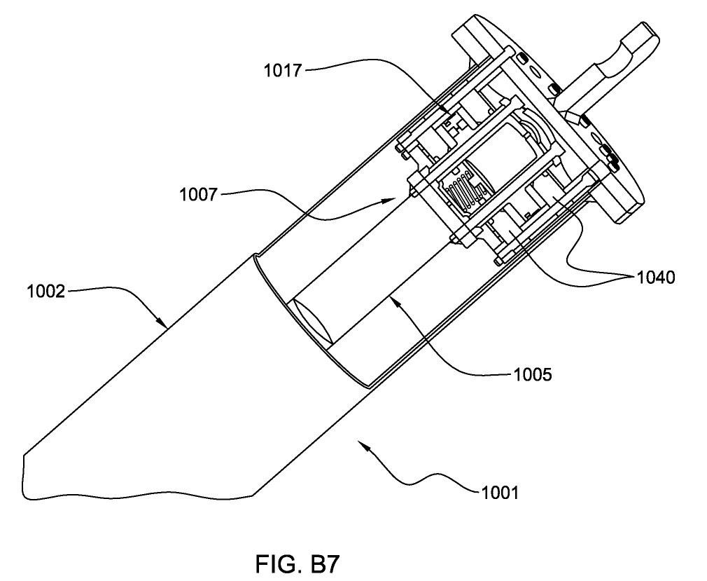

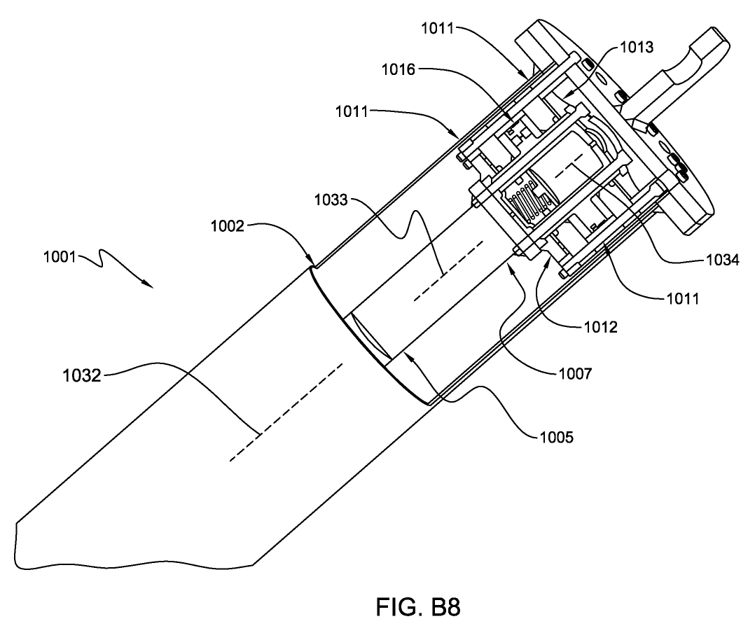

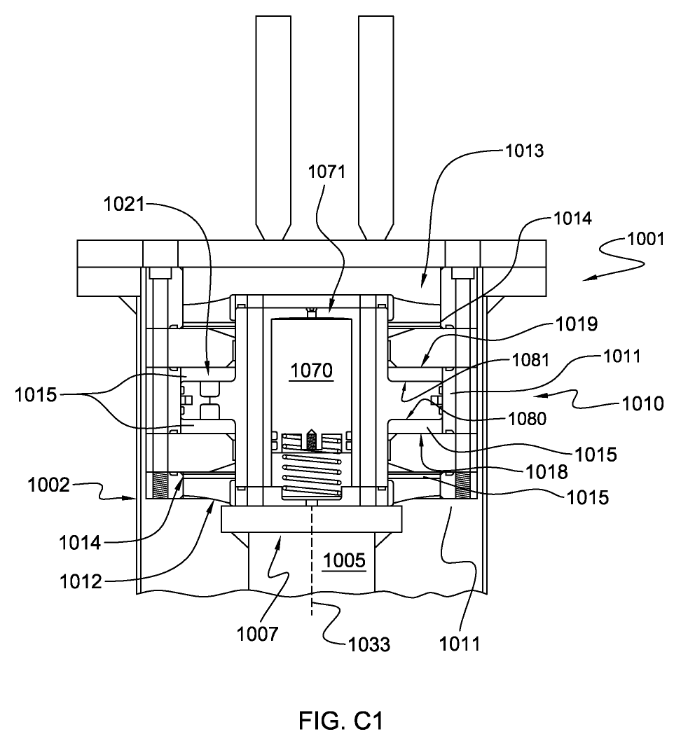

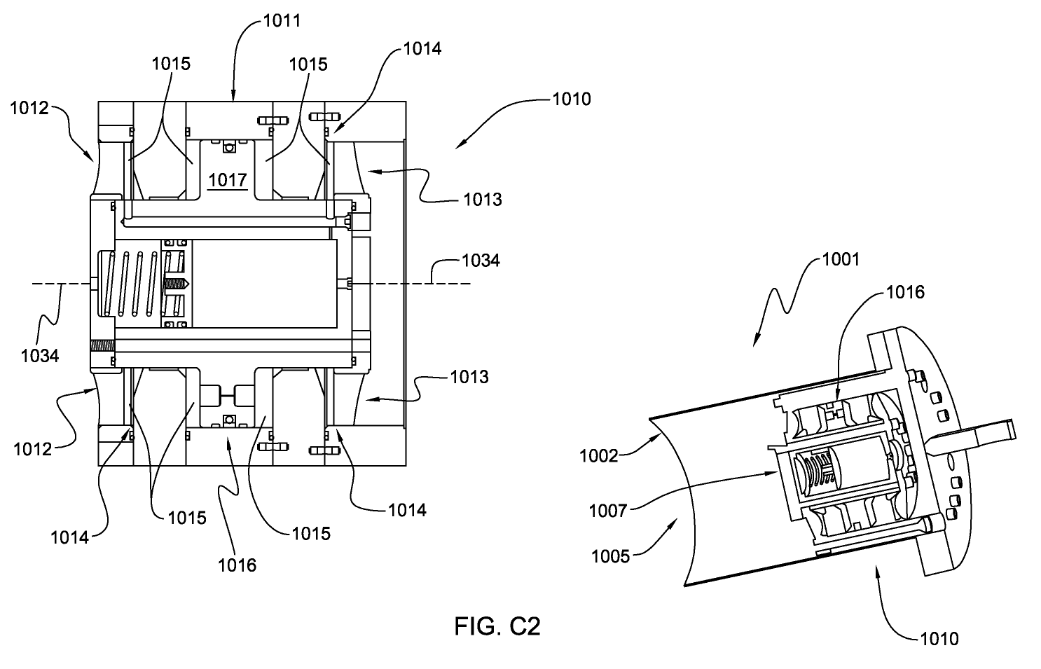

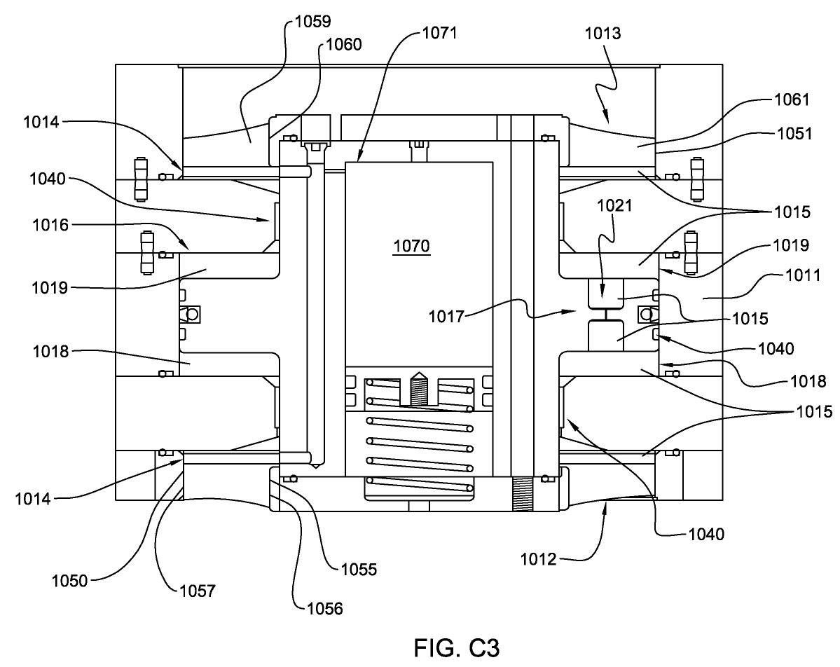

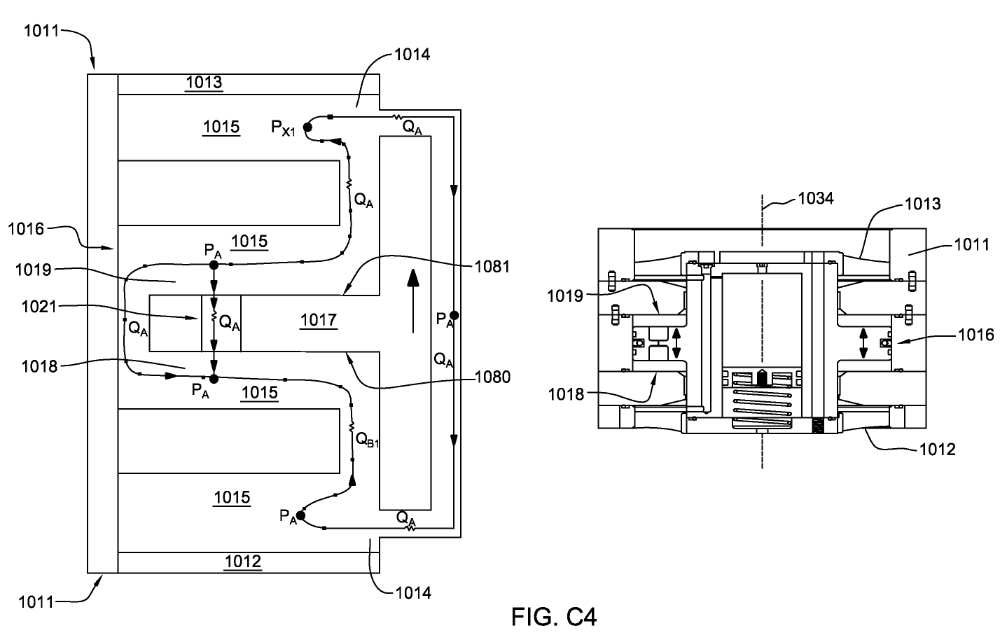

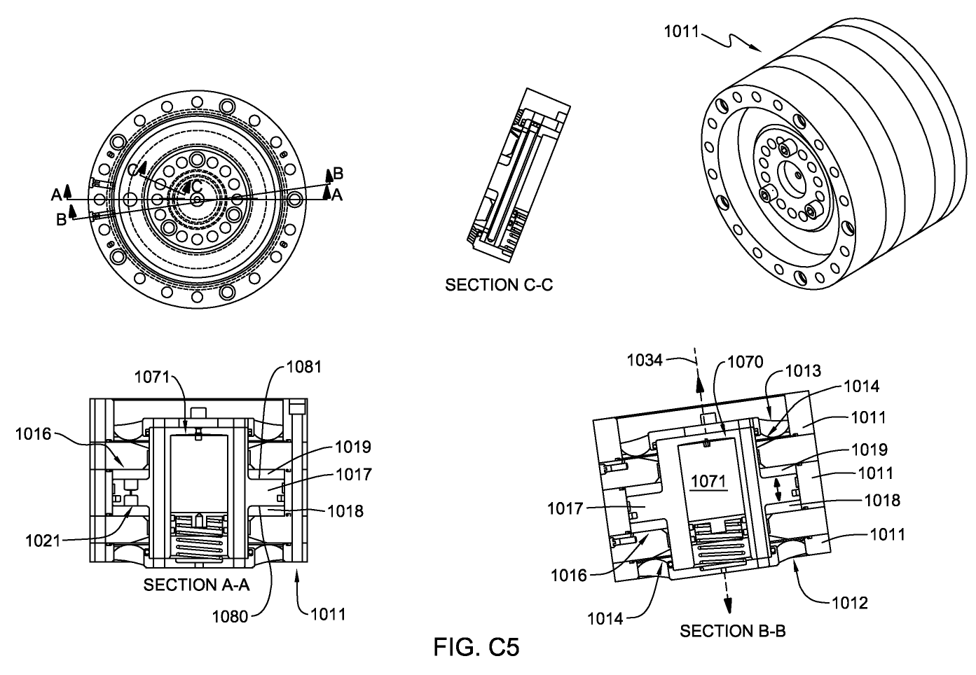

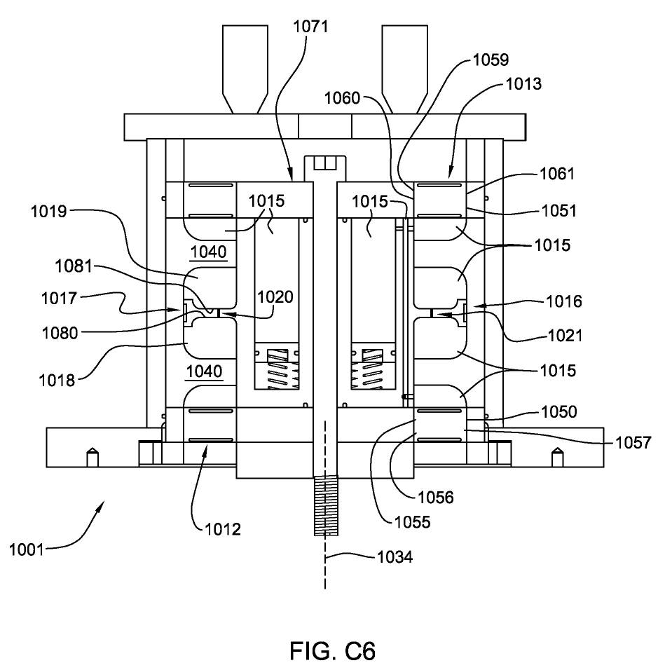

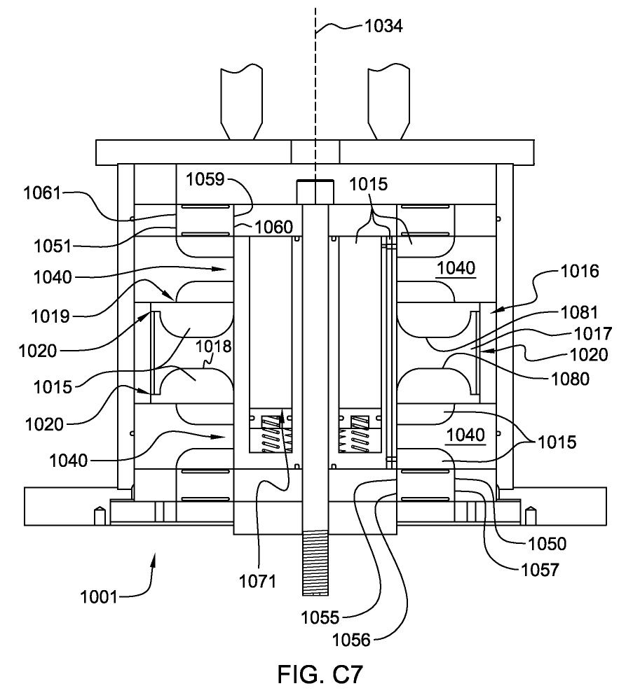

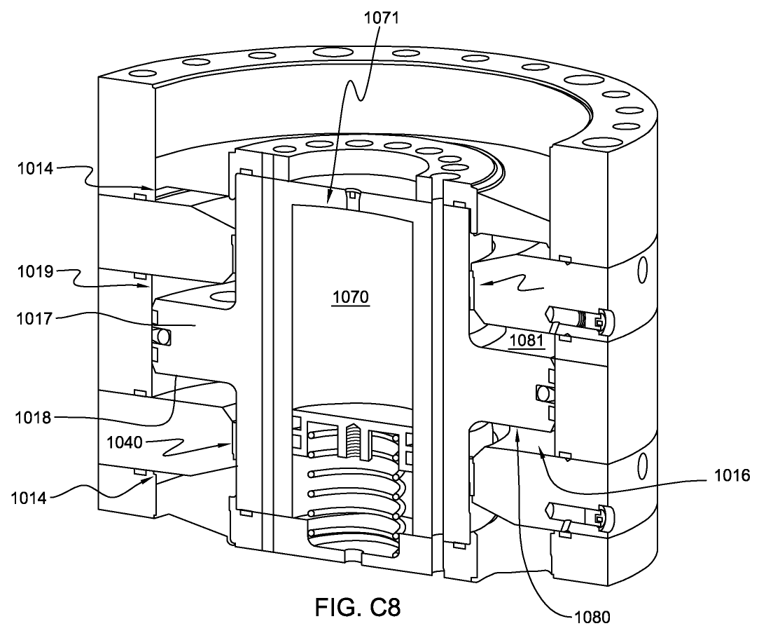

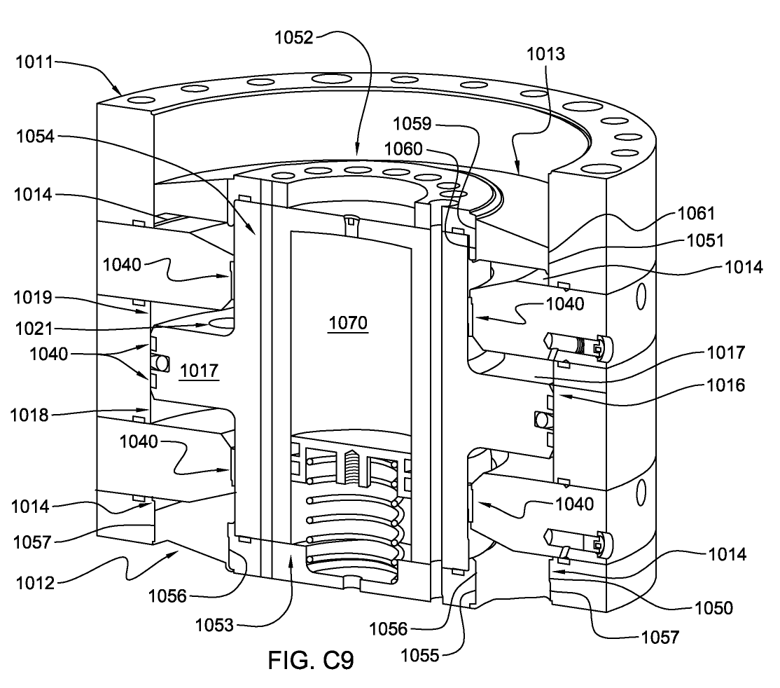

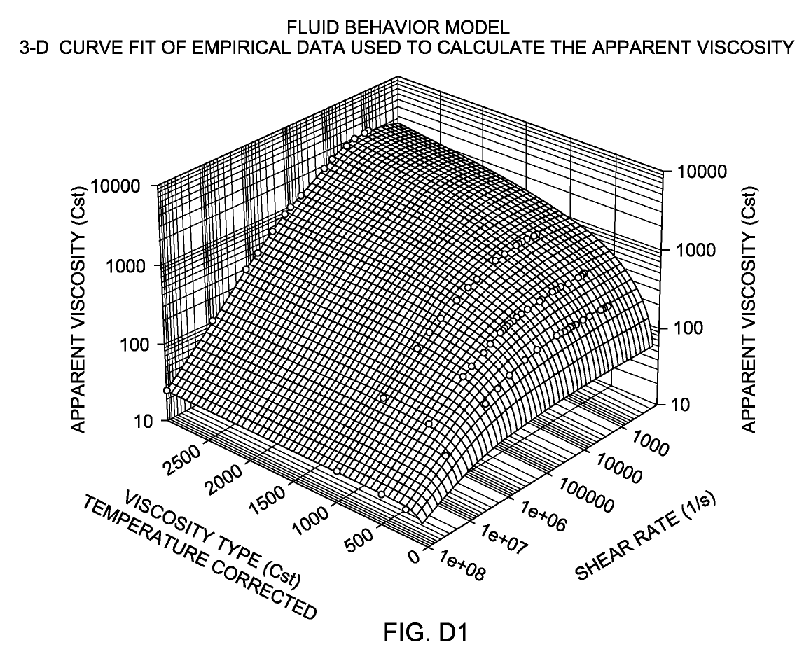

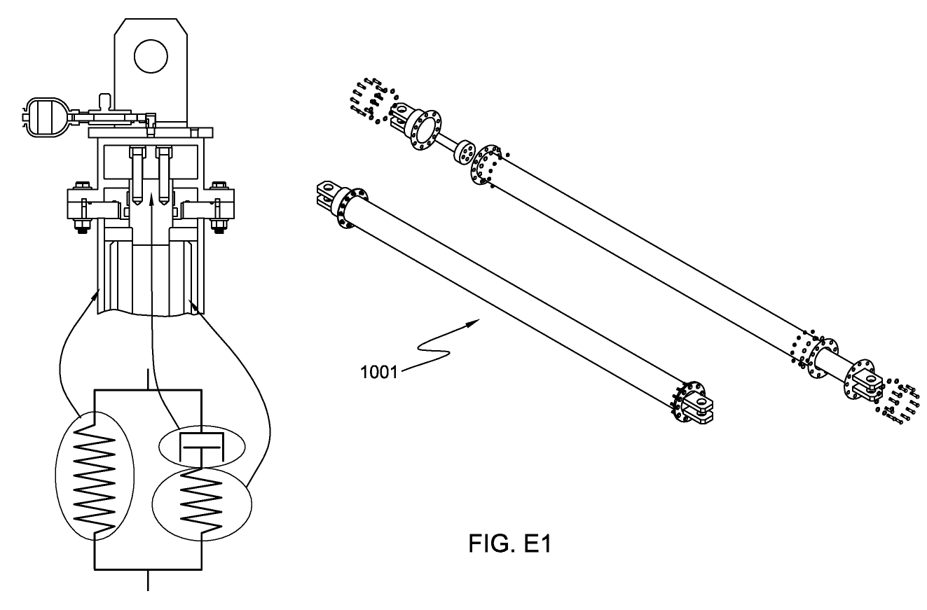

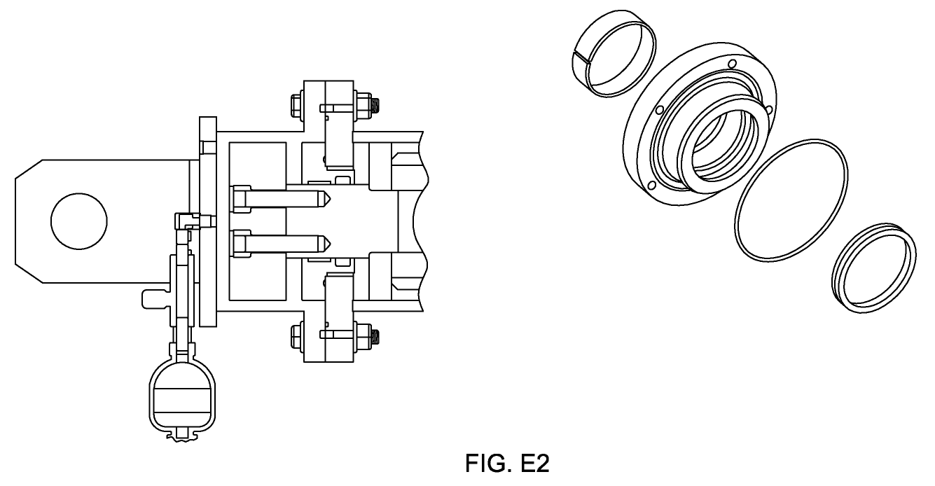

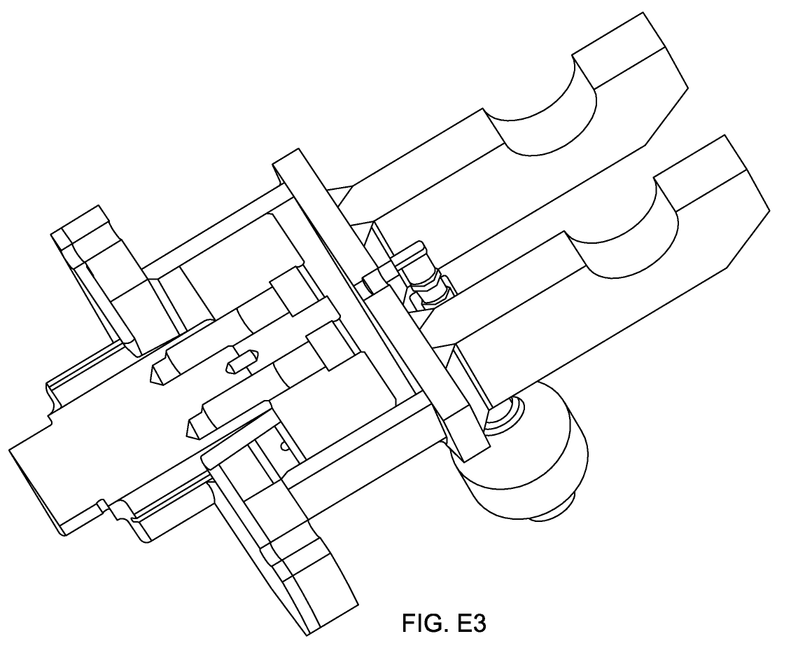

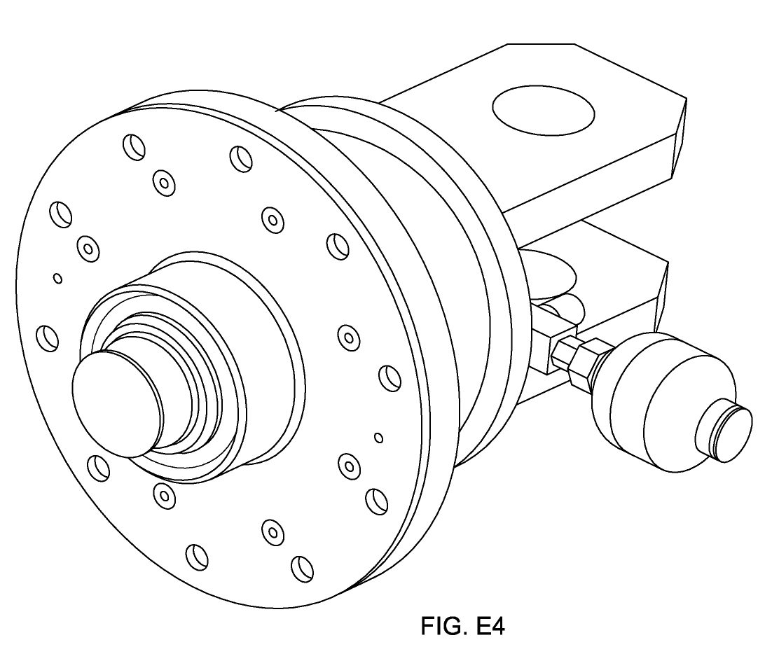

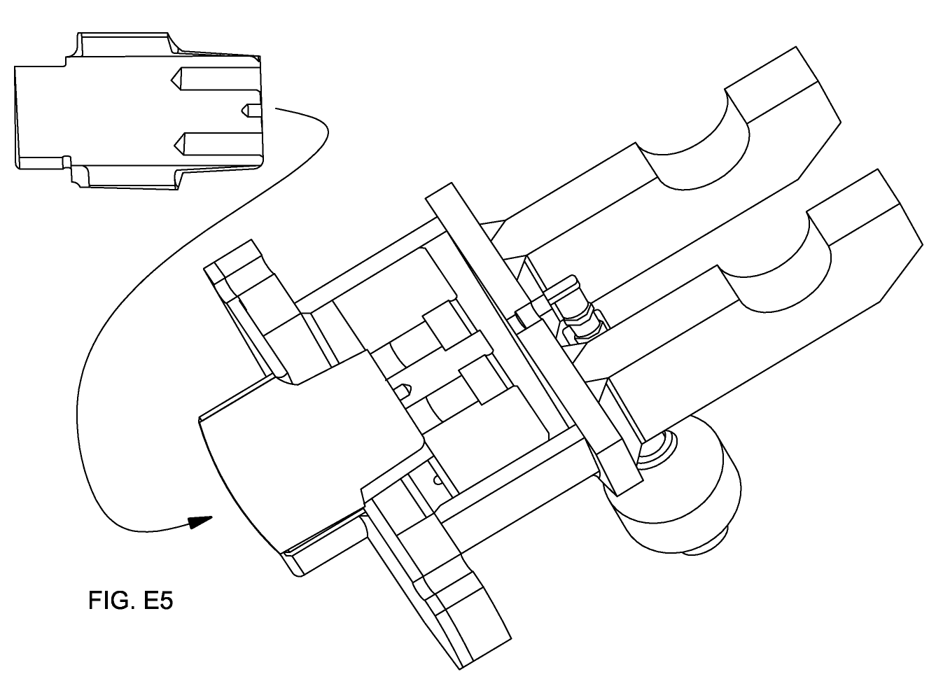

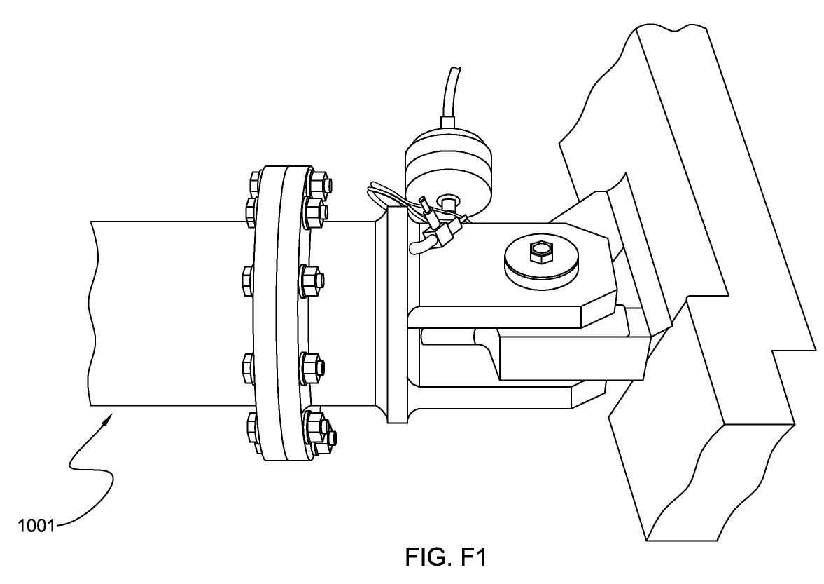

### CROSS REFERENCE

This application claims the benefit of, and incorporates by reference, U.S. Provisional Patent Application No. 60/899,492 filed Feb. 5, 2007.

### TECHNICAL FIELD OF THE INVENTION

The present invention relates to wind turbine systems and, more particularly, to wind turbine systems having damping members for damping troublesome, resonant or otherwise undesirable vibrations within the system, and more particularly to dampers for wind turbine systems.

### BACKGROUND OF THE INVENTION

There is a need for a wind turbine damper for damping an unwanted motion. There is a need for a damper for controlling motion and a method of accurately and economically damping troublesome motion in wind tower structures. There is a need for an economically feasible method of damping troublesome motion in wind tower structures. There is a need for a robust wind tower damper system and method of controlling wind tower motion.

### SUMMARY OF THE INVENTION

In an embodiment, the invention includes a wind turbine system damper. The damper includes a damper housing and a first elastomer seal and a second elastomer seal providing a fluid elastomeric chamber containing a damper fluid and an internal fluid pump. The internal fluid pump has a fluid moving piston, a first substantially fluid filled internal pumping chamber and a second substantially fluid filled internal pumping chamber in fluid communication with the fluid elastomeric chamber. The first substantially fluid filled internal pumping chamber and the second substantially fluid filled internal pumping chamber are in communication via at least one internal fluid damping orifice, wherein the troublesome structural movements drive the fluid moving piston to pump the fluid through the at least one internal fluid damping orifice.

In an embodiment, the invention includes a wind turbine tower damper. The damper includes a damper housing and a first elastomer seal and a second elastomer seal providing a fluid elastomeric chamber containing a damper fluid and an internal fluid pump, the internal fluid pump having a fluid moving piston, a first substantially fluid filled internal pumping chamber and a second substantially fluid filled internal pumping chamber in fluid communication with the fluid elastomeric chamber, the first substantially fluid filled internal pumping chamber and the second substantially fluid filled internal pumping chamber in communication via at least one internal fluid pump piston damping passage, wherein a relative motion between the second damping strut member second end and the first damping strut member second end drives the fluid moving piston to pump the fluid through the at least one internal fluid pump piston damping passage.

In an embodiment the invention includes a wind tower damping member for damping an unwanted motion in a wind tower. The damping member preferably includes a fluid elastomeric damper. The fluid elastomeric damper including a damper housing and a first elastomer seal and a second elastomer seal providing a fluid elastomeric chamber containing a damper fluid and an internal fluid pump, the internal fluid pump having a fluid moving piston, a first substantially fluid filled internal pumping chamber and a second substantially fluid filled internal pumping chamber in fluid communication with the fluid elastomeric chamber, the first substantially fluid filled internal pumping chamber and the second substantially fluid filled internal pumping chamber in communication via at least one internal fluid pump damping orifice. Unwanted motion drives the fluid moving piston to pump the fluid through the at least one internal fluid pump damping orifice.

In an embodiment, the invention includes a wind tower damper member for damping an unwanted motion in a wind tower. The fluid damper includes a damper housing and a first elastomer seal providing a fluid elastomeric chamber containing a damper fluid and a fluid moving piston, a first substantially fluid filled chamber and a second substantially fluid filled chamber wherein relative motion drives the fluid moving piston to pump the fluid with the piston pumping fluid dissipating the unwanted motion.

In an embodiment, the invention includes a wind turbine system including an at least 1.2 MW wind turbine system fluid damper, with the damper providing a means for damping troublesome turbine system movements.

In an embodiment, the invention includes a wind turbine tower fluid damper for damping structural resonant vibrations.

In an embodiment, the invention includes a wind tower fluid damper for damping an unwanted motion in a wind tower. It is to be understood that both the foregoing general description and the following detailed description are exemplary of the invention, and are intended to provide an overview or framework for understanding the nature and character of the invention as it is claimed. The accompanying drawings are included to provide a farther understanding of the invention, and are incorporated in and constitute a part of this specification. The drawings illustrate various embodiments of the invention, and together with the description serve to explain the principals and operation of the invention.

### DESCRIPTION

Additional features and advantages of the invention will be set forth in the detailed description which, follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

Referring to FIGS. A1-A4, a wind turbine system includes a wind turbine 14 supported by a wind turbine structural tower 10. Preferably the supported wind turbine 14 is a greater than 1.1 MW wind turbine, more preferably an at least 1.2 MW wind turbine, and more preferably an at least 1.5 MW wind turbine. Preferably the supported wind turbine 14 is a horizontal axis wind turbine with the wind turbine blades rotating about a substantially horizontal axis with the tower vertical axis substantially normal to the wind turbine rotary axis. The wind turbine system with the wind turbine 14 supported by the wind turbine structural tower 11 may have troublesome structural dynamic resonant vibration movements 1000. To damp such troublesome movements, the wind turbine structural tower 10 includes at least one damping member 1001.

Referring now also to FIGS. B1-B8, the damping member 1001 includes a first outer damping strut member 1002 having a first damping strut member first end 1003 and a first damping strut member second end 1004, the first outer damping strut member 1002 having a first damping strut member effective stiffness. The damping member 1001 includes a second inner damping strut member 1005, preferably disposed within the first outer damping strut member 1002. Preferably the second inner damping strut member 1005 has a second damping strut member first end 1006 and a second damping strut member second end 1007, preferably with the second damping strut member first end 1006 connected to the first damping strut member 1002 proximate the first damping strut member first end 1003. Preferably the second damping strut member 1005 has a second damping strut member effective stiffness, the second damping strut member effective stiffness different from the first damping strut member effective stiffness. In an embodiment, the second damping strut member 1005 is an inner steel shaft and the first damping strut member 1002 is an outer aluminum tube.

Referring now also to FIGS. C1-C9, the damping member 1001 includes a damper 1010 between the second damping strut member second end 1007 and the first damping strut member second end 1004. The damper 1010 includes a damper housing 1011 and a first elastomer end seal 1012 and a second elastomer end seal 1013 providing a fluid elastomeric chamber 1014 containing a damper fluid 1015 and an internal fluid pump 1016, the internal fluid pump having a fluid moving piston 1017, a first substantially fluid filled internal pumping chamber 1018 and a second substantially fluid filled internal pumping chamber 1019 in fluid communication with the fluid elastomeric chamber 1014. Preferably the internal pumping chambers 1018, 1019 are dynamically isolated and physically separated from the surrounding fluid elastomeric chamber 1014 they are submerged in. The first substantially fluid filled internal pumping chamber 1018 and the second substantially fluid filled internal pumping chamber 1019 are in communication via at least one internal fluid damping passage 1020, preferably a fluid damping orifice 1021, wherein the troublesome structural vibration movements 1000 drive the fluid moving piston 1017 to pump the fluid 1015 through the at least one internal fluid damping orifice passage 1021 with the pumping of the fluid through the internal fluid damping passage 1020 dissipating and inhibiting the structural movements 1000.

In a preferred embodiment the fluid damping passage 1020 has a moving wall, preferably with the fluid damping passage 1020 comprising an annulus with the damper having annular damping control. In a preferred embodiment the fluid damping passage 1020 is moving wall-free (has no moving passage walls), preferably with the moving wall-free fluid damping passage 1020 comprising an orifice with the damper having orifice damping control. The wind turbine structural tower 10 is comprised of a plurality of upwardly directed longitudinal members 20 and a plurality of diagonal members 26, preferably with the diagonal members interconnecting the longitudinal members, and a plurality of the damping members 1001 wherein the troublesome structural movements 1000 drive a plurality of damper fluid 1015 volumes through a plurality of internal fluid pump internal fluid damping passages 1020, preferably piston orifices 10221.

Preferably the damper fluid 1015 has a viscosity in the range from about 10 to about 100,000 centipoise. Preferably the damper fluid has a viscosity less than about 6,000 centipoise, more preferably no greater than about 5,000 centipoise, more preferably no greater than about 2,000 centipoise, and more preferably no greater than about 1,000 centipoise. Preferably the damper fluid is a silicon damper fluid with the damper fluid comprised of a silicon liquid. Preferably the damping member 1001 has a damping member longitudinally extending axis 1031, the first damping strut member having a first damping strut longitudinally extending axis 1032, the second damping strut member having a second damping strut longitudinally extending axis 1033, and the internal fluid pump fluid moving piston having a piston axis 1034 aligned with the damping member longitudinally extending axis 1031, the first damping strut longitudinally extending axis 1032, and the second damping strut longitudinally extending axis 1033 wherein the internal fluid pump fluid moving piston linearly reciprocates along the piston axis 1034. Preferably the damper 1010 includes a plurality of bearings 1040 providing for an axial movement of the fluid moving piston 1017.

In an embodiment, the wind turbine tower 10 for structurally supporting a wind turbine 14 preferably provides for the support of an at least 1.2 MW wind turbine, more preferably supporting an at least 1.5 MW wind turbine. Preferably tower 10 provides support for a horizontal axis wind turbine with the wind turbine blades 16 rotating about a substantially horizontal axis with the tower vertical axis substantially normal to the wind turbine rotary axis. Preferably the wind turbine tower 10 is comprised of a plurality of upward supporting structural members and at least one damping member 1001.

Preferably the damning member 1001 includes a first damping strut member 1002 having a first damping strut member first end 1003 and a first damping strut member second end 1004, the first damping strut member having a first damping strut member effective stiffness. Preferably the damping member 1001 includes a second damping strut member 1005 disposed within the first damping strut member 1002 and having a second damping strut member first end 1006 and a second damping strut member second end 1007. Preferably the second damping strut member first end is connected to the first damping strut member proximate the first damping strut member first end. The second damping strut member has a second damping strut member effective stiffness, the second damping strut member effective stiffness different from the first damping strut member effective stiffness.

Preferably the damping member 1001 includes a damper 1010 between the second damping strut member second end and the first damping strut member second end, the damper 1010 including a damper housing 1011 and a first elastomer end seal 1012 and a second elastomer end seal 1013 providing a fluid elastomeric chamber 1014 containing a damper fluid 1015 and an internal fluid pump 1016, the internal fluid pump having a fluid moving piston 1017, a first substantially fluid filled internal pumping chamber 1018 and a second substantially fluid filled internal pumping chamber 1019 in fluid communication with the fluid elastomeric chamber 1014 with the pumping chambers preferably dynamically isolated and physically separated from the surrounding fluid elastomeric chamber 1014 they are submerged in. The first substantially fluid filled internal pumping chamber and the second substantially fluid filled internal pumping chamber in fluid communication via at least one internal fluid pump piston damping passage 1020, preferably an orifice 1021, wherein a relative motion between the second damping strut member second end and the first damping strut member second end drives the fluid moving piston 1017 to pump the fluid through the at least one internal fluid pump piston damping passage. Preferably the troublesome structural vibration movements 1000 from wind forces and the operation of the turbine 14 remove the second damping strut member relative to the first damping strut member and drive the fluid moving piston to pump the fluid through the at least one internal fluid damping orifice passage with the pumping of the fluid through the internal fluid damping orifice passage dissipating and minimizing the troublesome structural movements.

Preferably the internal fluid pump fluid moving piston is grounded to the second damping strut member second end and the damper housing is grounded to the first damping strut member second end. Preferably the damper housing 1011 having a first nonelastomeric member bonding surface 1050 and a distal second nonelastomeric inner bonding surface 1051. Preferably the internal fluid pump fluid moving piston 1017 is integrated with an inner member 1052, the inner member 1052 including a first inner member longitudinal extension 1053 and a second inner member longitudinal extension 1054, the first inner member longitudinal extension having a nonelastomeric outer bonding surface 1055. Preferably the first elastomer seal has an inner bonding surface 1056 and an outer bonding surface 1057, the first elastomer seal inner bonding surface 1056 bonded to the first inner member longitudinal extension outer bonding surface 1055 and the first elastomer seal outer bonding surface 1057 bonded to the damper housing first inner bonding surface 1050. Preferably the second elastomer seal inner bonding surface 1059 is bonded to the second inner member longitudinal extension outer bonding surface 1060 and the second elastomer seal outer bonding surface 1061 is bonded to the damper housing second inner bonding surface 1051.

Preferably the damper includes a dynamically isolated accumulator 1070. Preferably the accumulator 1070 is dynamically isolated from the pumped fluid, preferably with the accumulator comprised of a variable volume compensator non-pumping fluid chamber 1071. Preferably the variable volume compensator non-pumping fluid chamber allows for thermal expansion and contraction of the fluid due to temperature changes. The compensator 1070 is non-pumping and dynamically isolated from the pumping chambers 1018, 1019, preferably with the accumulator compensator non-pumping fluid chamber 1071 inside the piston and damper inner member 1052.

Preferably the internal fluid pump fluid moving piston 1017 has a first fluid filled internal pumping chamber pump face surface area 1080 and a second fluid filled internal pumping chamber pump face surface area 1081, with the first fluid filled internal pumping chamber pump face surface area substantially equal to the second fluid filled internal pumping chamber pump face surface area. Preferably the piston orifice passage bridges the first pump face 1080 to second pump face 1081, orifice passage traversing from the first pump face to second pump face, with the longitudinally extending orifice passage axis preferably parallel to the piston axis. Preferably the orifice passage has a wide cross section first face orifice entrance relative to a narrow cross section damping middle orifice and back to a wide cross section second face orifice entrance.

Preferably the wind turbine structural tower is comprised of upwardly directed longitudinal members and diagonal members and a plurality of the damping members 1001 wherein troublesome structural movements drive a plurality of damper fluid volumes through a plurality of internal fluid pump internal fluid damping orifice passages. Preferably the damper fluid 1015 has a viscosity in the range from about 10 to about 100,000 centipoise. Preferably the damper fluid has a viscosity less than about 6,000 centipoise, more preferably no greater than about 5,000 centipoise, more preferably no greater than about 2,000 centipoise, and more preferably no greater than about 1,000 centipoise. Preferably the damper fluid is a silicon damper fluid with the damper fluid comprised of a silicon liquid. Preferably the damping member 1001 has a damping member longitudinally extending axis 1031, the first damping strut member having a first damping strut longitudinally extending axis 1032, the second damping strut member having a second damping strut longitudinally extending axis 1033, and the internal fluid pump fluid moving piston having a piston axis 1034 aligned with the damping member longitudinally extending axis 1031, the first damping strut longitudinally extending axis 1032, and the second damping strut longitudinally extending axis 1033 wherein the internal fluid pump fluid moving piston linearly reciprocates along the piston axis 1034.

Preferably the damper 1010 includes a plurality of bearings 1040 providing for an axial movement of the fluid moving piston 1017. Preferably the bearings center the piston and provide for its reciprocating axial motion along the piston axis. Preferably the bearings include inwardly lateral extending first bearing member separating the first pumping chamber from the fluid elastomeric chamber and second inwardly extending lateral bearing member separating the second pumping chamber from the fluid elastomeric chamber. Preferably the piston includes a bearing and preferably a weeping seal between the piston outer perimeter and the inner surface of the damper housing. Preferably the piston damper inner member includes a transfer tube for fluid flow in the fluid elastomeric chamber outside the pumping chambers. Preferably the piston damper inner member includes an isolating accumulator passage for low fluid flow into and out of the compensator chamber 1071.

In an embodiment, the wind tower damping member 1001 for damping the unwanted motion in the wind tower includes the first damping strut member having the first damping strut member first end and the first damping strut member second end, the first damping strut member having the first damping strut member effective stiffness. Preferably the damping member 1001 provides damping for the space frame construction structural tower supporting the greater than 1.1 MW wind turbine with the plurality of vertical, horizontal, and diagonal structural members joined and secured together. Preferably the damper provides damping for a tower supporting an at least 1.2 MW wind turbine, more preferably an at least 1.5 MW wind turbine, preferably with the wind turbine having a horizontal axis with the wind turbine blades rotating about the substantially horizontal axis with the tower vertical axis substantially normal to the wind turbine rotary axis. Preferably the second damping strut member is aligned with, and preferably disposed within, the first damping strut member and has the second damping strut member first end and the second damping strut member second end, the second damping strut member first end connected to the first damping strut member proximate the first damping strut member first end, the second damping strut member having the second damping strut member effective stiffness different from the first damping strut member effective stiffness.

The damping member 1001 includes the fluid elastomeric damper between the second damping strut member second end and the first damping strut member second end, the fluid elastomeric damper including the damper housing and the first elastomer end seal and the second elastomer end seal providing the fluid elastomeric chamber containing the damper fluid and the internal fluid pump. The internal fluid pump preferably has the fluid moving piston, the first substantially fluid filled internal pumping chamber and the second substantially fluid filled internal pumping chamber in fluid communication with the fluid elastomeric chamber. Preferably the first substantially fluid filled internal pumping chamber and the second substantially fluid filled internal pumping chamber are in communication via at least one internal fluid pump damping orifice passage, wherein the relative motion between the second damping strut member second end and the first damping strut member first end drives the fluid moving piston to pump the fluid through the at least one internal fluid pump damping orifice. Preferably troublesome structural vibration movements from wind forces and the operation of the turbine move the second damping strut member relative to the first damping strut member and drive the fluid moving piston to pump the fluid through the at least one internal fluid damping passage with the pumping of the fluid through the internal fluid damping passage dissipating and minimizing the structural movements.

Preferably the damping member internal fluid pump fluid moving piston is grounded to the second damping strut member second end and the damper housing is grounded to the first damping strut member second end. Preferably the damping member has the damper housing having the first damper end nonelastomeric inner bonding surface and the longitudinally distal second damper end nonelastomeric inner bonding surface, the internal fluid pump fluid moving piston integrated with an inner damper member, the inner damper member including the first end inner damper member longitudinal extension and the second end distal inner damper member longitudinal extension, the first end inner damper member longitudinal extension having an nonelastomeric outer bonding surface, the first elastomer seal having an inner bonding surface and an outer bonding surface, the first elastomer seal inner bonding surface bonded to the first inner damper member longitudinal extension outer bonding surface and the first elastomer seal outer bonding surface bonded to the damper housing first inner bonding surface. Preferably the second inner damper member longitudinal extension has an nonelastomeric outer bonding surface, the second elastomer seal having an inner bonding surface an outer bonding surface, the second elastomer seal inner bonding surface bonded to the second inner damper member longitudinal extension outer bonding surface and the second elastomer seal outer bonding surface bonded to the damper housing second inner bonding surface.

Preferably the damper includes the variable volume compensator nonpumping fluid chamber, with the variable volume compensator non-pumping fluid chamber allowing for thermal expansion and contraction of the fluid due to temperature changes, preferably with the fluid compensator chamber non-pumping and dynamically isolated from the pumping chambers, with the dynamically isolated accumulator dynamically isolated from pumped fluid. Preferably the accumulator compensator non-pumping fluid chamber is inside the piston and damper inner member. Preferably the internal fluid pump fluid moving piston has the first fluid filled internal pumping chamber pump face surface area and the second fluid filled internal pumping chamber pump face surface area, with the first fluid filled internal pumping chamber pump face surface area substantially equal to the second fluid filled internal pumping chamber pump face surface area. Preferably the piston orifice bridges first pump face to second pump face, with orifice traversing from first pump face to second pump face with a longitudinally extending orifice axis preferably parallel to piston axis. Preferably the orifice passage has a wide cross section first face orifice entrance to relative to the narrow cross section damping middle orifice with the narrow cross section opening back up to the relative wide cross section second face orifice entrance.

Preferably the damper fluid 1015 has a viscosity in the range from about 10 to about 100,000 centipoise. Preferably the damper fluid has a viscosity less than about 6,000 centipoise, more preferably no greater than about 5,000 centipoise, more preferably no greater than about 2,000 centipoise, and more preferably no greater than about 1,000 centipoise. Preferably the damper fluid is a silicon damper fluid with the damper fluid comprised of a silicon liquid. Preferably the damping member 1001 have a damping member longitudinally extending axis 1031, the first damping strut member having a first damping strut longitudinally extending axis 1032, the second damping strut member having a second damping strut longitudinally extending axis 1033, and the internal fluid pump fluid moving piston having a piston axis 1034 aligned with the damping member longitudinally extending axis 1031, the first damping strut longitudinally extending axis 1032, and the second damping strut longitudinally extending axis 1033 wherein the internal fluid pump fluid moving piston linearly reciprocates along the piston axis 1034. Preferably the damper 1010 includes a plurality of bearings 1040 providing for an axial movement of the fluid moving piston 1017. Preferably the bearings center the piston and provide for its reciprocating axial motion along the piston axis. Preferably the bearings include inwardly lateral extending first bearing member separating the first pumping chamber from the fluid elastomeric chamber and second inwardly extending lateral bearing member separating the second pumping chamber from the fluid elastomeric chamber. Preferably the piston includes at least one bearing and preferably a weeping seal between the piston outer perimeter and the inner surface of the damper housing. Preferably the piston damper inner member includes a transfer tube for fluid flow in the fluid elastomeric chamber outside the pumping chambers. Preferably the piston damper inner member includes an isolating accumulator passage for low fluid flow into and out of the compensator chamber 1071.

In an embodiment, the wind tower damping member for damping an unwanted motion in the wind tower includes the first damping strut member, preferably having the first damping strut member first end and the first damping strut member second end, the first damping strut member having the first damping strut member effective stiffness. The wind tower damping member includes the second damping strut member aligned with, and preferably disposed within, the first damping strut member, the second strut member preferably having the second damping strut member first end and the second damping strut member second end, the second damping strut member first end connected to the first damping strut member proximate the first damping strut member first end, the second damping strut member having the second damping strut member effective stiffness, the second damping strut member effective stiffness different from the first damping strut member effective stiffness.

The wind tower damping member includes the fluid damper between the second damping strut member and the first damping strut member, the fluid elastomeric damper including the damper housing and the first elastomer end seal and preferably the second elastomer end seal. The housing and elastomer seal providing the fluid elastomeric chamber containing the damper fluid and the fluid moving piston, the first substantially fluid filled chamber and the second substantially fluid filled chamber, preferably the internal fluid pump with internal fluid moving piston and internal fluid pump first and second chambers, wherein the relative motion between the second damping strut member and the first damping strut member drives the fluid moving piston to pump the fluid with the piston pumping fluid dissipating the unwanted motion. Preferably the housing having the first damper end nonelastomeric inner bonding surface and the longitudinally distal second damper end nonelastomeric inner bonding surface, the internal fluid pump fluid moving piston integrated with an inner damper member, the inner damper member including the first end inner damper member longitudinal extension and the second end distal inner damper member longitudinal extension, the first end inner damper member longitudinal extension having an nonelastomeric outer bonding surface, the first elastomer seal having an inner bonding surface and an outer bonding surface, the first elastomer seal inner bonding surface bonded to the first inner damper member longitudinal extension outer bonding surface and the first elastomer seal outer bonding surface bonded to the damper housing first inner bonding surface. Preferably the second inner damper member longitudinal extension has an nonelastomeric outer bonding surface, the second elastomer seal having an inner bonding surface an outer bonding surface, the second elastomer seal inner bonding surface bonded to the second inner damper member longitudinal extension outer bonding surface and the second elastomer seal outer bonding surface bonded to the damper housing second inner bonding surface.

In an embodiment, the invention includes a wind turbine system including an at least 1.2 MW wind turbine supported by a wind turbine structural tower, the wind turbine structural tower having a plurality of troublesome structural movements, with the wind turbine structural tower including a means for damping the troublesome structural movements. Preferably the wind turbine is an at least 1.5 MW wind turbine. The at least 1.2 MW wind turbine is supported by the wind turbine structural tower, the wind turbine structural tower having the plurality of troublesome structural resonant vibration movements, the wind turbine structural tower including a means for damping the troublesome structural movements. Preferably the means for damping includes a plurality of spaced apart separate damping members 1001, the damping members including the first damping strut members having the first damping strut member first end and the first damping strut member second end, the first damping strut member having the first damping strut member effective stiffness, a second damping strut member aligned within the first damping strut member and having a second damping strut member first end and a second damping strut member second end (the second damping strut member first end connected to the first damping strut member proximate the first damping strut member first end), the second damping strut member having a second damping strut member effective stiffness, the second damping strut member effective stiffness different from the first damping strut member effective stiffness.

The damping members include the damper 1011 between the second damping strut member (second end) and the first damping strut member (first end), the damper including the damper housing and the first elastomer seal and the second elastomer seal providing the fluid elastomeric chamber containing the damper fluid and the internal fluid pump, the internal fluid pump having the fluid moving piston, the first substantially fluid filled internal pumping chamber and the second substantially fluid filled internal pumping chamber in fluid communication with the fluid elastomeric chamber, the first substantially fluid filled internal pumping chamber and the second substantially fluid filled internal pumping chamber in communication via at least one internal fluid damping passage, wherein the troublesome structural movements drive the fluid moving piston to pump the fluid through the at least one internal fluid damping orifice with the pumping of the fluid through the internal fluid damping orifice dissipating and minimizing the structural movements. Preferably the means for damping the troublesome structural movements includes a plurality of internal fluid pumps, the internal fluid pumps each having a fluid moving piston pumping a damper fluid between a first substantially fluid filled internal pumping chamber and a second substantially fluid filled internal pumping chamber through a piston damping orifice.

In an embodiment, the wind turbine tower is comprised of a plurality of structural members, a means for connecting the plurality of structural members together to provide an upwardly extending tower structure 10 having a structural resonant vibration, and a means for damping the structural resonant vibration. Preferably the means for damping the structural vibration includes a plurality of damping strut members 1001. Preferably the means for damping the structural vibration includes a plurality of fluid elastomeric dampers 1010.

Preferably the dampers have a first damping strut member first end and a first damping start member second end, the first damping strut member having a first damping strut member effective stiffness, a second damping strut member disposed within the first damping strut member and having a second damping strut member first end and a second damping strut member second end, the second damping strut member first end connected to the first damping strut member proximate the first damping strut member first end, the second damping strut member having a second damping strut member effective stiffness, the second damping strut member effective stiffness different from the first damping strut member effective stiffness, and a damper between the second damping strut member second end and the first damping strut member second end, the damper including a damper housing and a first elastomer seal and a second elastomer seal providing a fluid elastomeric chamber containing a damper fluid and an internal fluid pump, the internal fluid pump having a fluid moving piston, a first substantially fluid filled internal pumping chamber and a second substantially fluid filled internal pumping chamber in fluid communication with the fluid elastomeric chamber, the first substantially fluid filled internal pumping chamber and the second substantially fluid filled internal pumping chamber in communication via at least one internal fluid pump piston damping passage, preferably an orifice, wherein a relative motion between the second damping strut member second end and the first damping strut member second end drives the fluid moving piston to pump the fluid through the at least one internal fluid pump piston damping passage. Preferably troublesome structural vibration movements from wind forces and the operation of the turbine move the second damping strut member relative to the first damping strut member and drive the fluid moving piston to pump the fluid through the at least one internal fluid damping passage with the pumping of the fluid through the internal fluid damping passage dissipating and minimizing the structural movements.

In an embodiment, the wind tower damping member for damping an unwanted motion in a wind tower includes a first damping strut member having a first damping strut member first end and a first damping strut member second end, the first damping strut member having a first damping strut member effective stiffness, a second damping strut member aligned with the first damping strut member and having a second damping strut member first end and a second damping strut member second end, the second damping strut member first end connected to the first damping strut member proximate the first damping strut member first end, the second damping strut member having a second damping strut member effective stiffness, the second damping strut member effective stiffness different from the first damping strut member effective stiffness, and a means for damping a relative movement between the first damping strut member and the second damping strut member.

Preferably the means for damping includes a fluid elastomeric damper. Preferably the means for damping includes a fluid elastomeric damper containing an internal fluid pump submerged in a damper fluid, the internal fluid pump having a fluid moving piston pumping the damper fluid between a first substantially fluid filled internal pumping chamber and a second substantially fluid filled internal pumping chamber through a piston damping orifice. Preferably the means for damping includes a means for pumping a damper fluid through an orifice.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

1. A wind turbine system structural tower damper for damping, said damper including a damper housing and a first elastomer seal and a second elastomer seal providing a fluid elastomeric chamber containing a damper fluid and an Internal fluid pump, said internal fluid pump having a fluid moving piston, a first substantially fluid filled internal pumping chamber and a second substantially fluid filled internal pumping chamber in fluid communication with said fluid elastomeric chamber, said first substantially fluid filled internal pumping chamber and said second substantially fluid filled internal pumping chamber in communication via at least one internal fluid damping orifice, wherein said troublesome structural movements drive said fluid moving piston to pump said fluid through said at least one internal fluid damping orifice.

2. A wind turbine system damper as claimed in claim 1, said fluid having a viscosity in the range from about 10 to about 100,000 centipoise.

3. A wind turbine system damper as claimed in claim 1, and said internal fluid pump fluid moving piston having a piston axis, said axis longitudinally extending, and wherein said internal fluid pump fluid moving piston linearly reciprocates along said piston axis.

4. A wind turbine system damper as claimed in claim 1, including a plurality of bearings providing for all axial movement of said fluid moving piston.

5. A wind turbine tower damper, said damper including a damper housing and a first elastomer seal and a second elastomer seal providing a fluid elastomeric chamber containing a damper fluid and an internal fluid pump, said internal fluid pump having a fluid moving piston, a first substantially fluid filled internal pumping chamber and a second substantially fluid filled internal pumping chamber in fluid communication with said fluid elastomeric chamber, said first substantially fluid filled internal pumping chamber and said second substantially fluid filled internal pumping chamber in communication via at least one internal fluid pump piston damping orifice, wherein a relative motion drives said fluid moving piston to pump said fluid through said at least one internal fluid pump piston damping orifice.

6. A wind turbine tower damper as claimed in claim 5, wherein said internal fluid pump fluid moving piston is grounded to a second structure and said damper housing is grounded to a first structure.

7. A wind turbine tower damper as claimed in claim 5, wherein said damper housing having a first inner bonding surface and a distal second inner bonding surface, said internal fluid pump fluid moving piston is integrated with an inner member, said inner member including a first inner member longitudinal extension and a second inner member longitudinal extension, said first inner member longitudinal extension having an outer bonding surface, said first elastomer seal having an inner bonding surface and an outer bonding surface, said first elastomer seal inner bonding surface bonded to said first inner member longitudinal extension outer bonding surface and said first elastomer seal outer bonding surface bonded to said damper housing first inner bonding surface, said second elastomer seal inner bonding surface bonded to said second inner member longitudinal extension outer bonding surface and said second elastomer seal outer bonding surface bonded to said damper housing second inner bonding surface.

8. A wind turbine tower damper as claimed in claim 5, said damper including an isolated accumulator.

9. A wind turbine tower damper as claimed in claim 5, said internal fluid pump fluid moving piston having a first fluid filled internal pumping chamber pump face surface area and a second fluid filled internal pumping) chamber pump face surface area, with said first fluid filled internal pumping chamber pump face surface area substantially equal to said second fluid filled internal pumping chamber pump face surface area.

10. A wind turbine tower damper as claimed in claim 5, said fluid having a viscosity less than about 6,000 centipoise.

11. A wind turbine tower damper as claimed in claim 5, said internal fluid pump fluid moving piston having a piston axis, said piston axis longitudinally extending, wherein said internal fluid pump fluid moving piston linearly reciprocates along said piston axis.

12. A wind turbine tower damper as claimed in claim 11, including a plurality of bearings members providing for an axial movement of said fluid moving piston.

13. A wind tower damper for damping an unwanted motion in a wind tower, said damper comprised of a fluid elastomeric damper including a damper housing and a first elastomer seal and a second elastomer seal providing a fluid elastomeric chamber containing a damper fluid and an internal fluid pump, said internal fluid pump having a fluid moving piston, a first substantially fluid filled internal pumping chamber and a second substantially fluid filled internal pumping chamber in fluid communication with said fluid elastomeric chamber, said first substantially fluid filled internal pumping chamber and said second substantially fluid filled internal pumping chamber in communication via at least one internal fluid pump damping passage, wherein a relative motion between a second wind tower structure member and a first wind tower structure member drives said fluid moving piston to pump said fluid through said at least one internal fluid pump damping passage.

14. A damper as claimed in claim 13, said damper housing having a first damper end inner bonding surface and a distal second damper end inner bonding surface, said internal fluid pump fluid moving piston integrated with an inner damper member, said inner damper member including a first end inner damper member longitudinal extension and a second end inner damper member longitudinal extension, said first end inner damper member longitudinal extension having an outer bonding surface, said first elastomer seal having an inner bonding surface and an outer bonding surface, said first elastomer seal inner bonding surface bonded to said first inner damper member longitudinal extension outer bonding surface and said first elastomer seal outer bonding surface bonded to said damper housing first inner bonding surface.

15. A damper as claimed in claim 14 wherein said second inner damper member longitudinal extension has an outer bonding surface, said second elastomer seal having an inner bonding surface an outer bonding surface, said second elastomer seal inner bonding surface bonded to said second inner damper member longitudinal extension outer bonding surface and said second elastomer seal outer bonding surface bonded to said damper housing second inner bonding surface.

16. A damper as claimed in claim 13, said damper including a variable volume compensator non-pumping fluid chamber

17. A damper as claimed in claim 13, said internal fluid pump fluid moving piston having a first fluid filled internal pumping chamber pump face surface area and a second fluid filled internal pumping chamber pump face surface area, with said first fluid filled internal pumping chamber pump face surface area substantially equal to said second fluid filled internal pumping chamber pump face surface area.

18. A damper as claimed in claim 13, said damper fluid having a viscosity no greater than about 5,000 centipoise.

19. A damper as claimed in claim 13, wherein said internal fluid pump fluid moving piston linearly reciprocates along a longitudinally extending piston axis.

20. A damper as claimed in claim 19, said damper including a plurality of bearings members providing for an axial movement of said fluid moving piston.

21. A damper as claimed in claim 13, said piston including at least one bearing and a seal between said piston and said housing.

22. A wind tower fluid damper for damping an unwanted motion in a wind tower,
said fluid damper including a damper housing and a first elastomer seal providing a fluid elastomeric chamber containing a damper fluid and a fluid moving piston,
a first substantially fluid filled internal pump chamber and a second substantially fluid filled internal pump chamber,
wherein a relative motion drives said fluid moving piston to pump said fluid with said piston pumping fluid dissipating said unwanted motion.

23. A method of damping said turbine system motion, said method includes providing an internal fluid pump, said internal fluid pump having a fluid moving piston pumping a damper fluid between a first substantially fluid filled internal pumping chamber and a second substantially fluid filled internal pumping chamber through a piston damping orifice.

24. A method of damping an unwanted motion in a wind tower, said method includes providing a fluid elastomeric damper containing an internal fluid pump submerged in a damper fluid, said internal fluid pump having a fluid moving piston pumping said damper fluid between a first substantially fluid filled internal pumping chamber and a second substantially fluid filled internal pumping chamber, and coupling said fluid elastomeric damper with a first tower structure and a second tower structure wherein said unwanted motion pumps said damper fluid.

25. A damping member as claimed in claim 24, wherein said damper fluid is pumped through an orifice.
